(19) United States
(12) Patent Application Publication
(10) Pub. No.: US 2009/0121490 A1
(43) Pub. Date: May 14, 2009

(54) Oscillating-Wing Power Generator with Flow-Induced Pitch-Plunge Phasing

(76) Inventors: Maximilian F. Platzer, Pebble Beach, CA (US); Richard A. Bradley, Carmel Valley, CA (US)

Correspondence Address: Maximilian F . Platzer, 3070 Hermitage Road, Pebble Beach, CA, 93953, US

(21) Appl. No.: 12/266,553

(22) Filed: Nov. 7, 2008

Related U.S. Application Data
(60) Provisional application No. 61/002,883, filed on Nov. 13, 2007.

(51) Int. Cl. F03D 9/00

(52) U.S. Cl. 290/55

(57) ABSTRACT

A new method for converting the kinetic energy of wind or water flows into electric energy, comprising wings or sails which are mounted on swing arms or on guide rails in such a way that the air or water flow induces an oscillatory wing or sail motion with a phase angle between the wing's or sail's pitch and plunge motion of about ninety degrees. Stroke reversal of the oscillatory motion is initiated by a purely aerodynamic/hydrodynamic mechanism such that the air or water flow induces a pitching moment on the wing or sail which rotates the wing or sail and thereby reverses the lift acting on the wing or sail.

### BACKGROUND OF THE INVENTION

1. Field of the Invention

This invention relates in general to wings and sails, and in particular to wings and sails which oscillate in such a way that they convert the energy of flowing air or water into electrical energy.

2. Discussion of the Related Art

The phenomenon of wing flutter is well known to aeronautical engineers, whereby an aircraft wing may experience catastrophic failure in a few seconds due to the fact that the wing may absorb energy from the air flow. This type of flutter usually requires that the wing is free to oscillate in at least two degrees of freedom, say in bending and torsion. It follows that if an airfoil is mechanically coupled in pitch and plunge it can extract energy from the flow. This is shown in FIG. 1.

It is feasible to construct an oscillating wing power generator for the purpose of extracting useful power from a flow. In 1981, McKinney and DeLaurier built such a device at the University of Toronto which they described in the Journal of Energy, Vol. 5, No. 2, pp. 109-115, “The Wingmill: An Oscillating-Wing Windmill”. It consists of a horizontally mounted wing whose plunging motion is transformed into a rotary shaft motion. The wing is pivoted to pitch at its half-chord location by means of a fitting which is rigidly attached to the vertical support shaft. Also fixed to the support shaft is the outer sleeve of a push-pull cable whose end pivots on a wing-fixed lever to control the wing's pitch. The up-and-down motion of the support shaft is transformed, through a Scotch-yoke mechanism, into a rotary motion of a horizontal shaft. This shaft, in turn, operates a crank at its far end which actuates the previously mentioned pitch-control cable. Hence the wing's pitching and plunging motions are articulated together at a given frequency and phase angle. Wind tunnel tests of this device showed that this type of power generator is capable of converting wind energy into electricity with an efficiency approaching that of conventional windmills.

In recent years, K. D. Jones, S. T. Davids, M. F. Platzer and K. D. Jones, K. Lindsey, M. F. Platzer built similar wingmills for use in water flows which they described in the Proceedings of the 3^{rd} ASME/JSME Joint Fluids Engineering Conference, San Francisco, July 1999 and in the Proceedings of the Second International Conference on Fluid Structure Interaction II, WIT Press 2003, pp. 73-82, respectively. They showed that this type of power generator is capable of converting water flow energy into electricity. Furthermore, the company Engineering Business Ltd in Riding Mill, Northumberland, England, built and tested an oscillating-wing hydropower generator, called “Stingray”, which produced an output of 150 kW. They also performed computations which showed that optimum power extraction performance requires large plunge amplitudes (of the order of the wing chord) and large pitch angles (70 to 80 degrees).

These prior art oscillating-wing power generators have the disadvantage of requiring a rather elaborate mechanism to enforce the wing's pitch-plunge motion at the proper phase angle between the pitch and plunge motions.

Very recently, O. J. Birkestrand's application for a “fluid-responsive oscillation power generation method and apparatus” was published on 26 Jun. 2008 in U.S.2008/0148723. In this invention an airfoil is mounted on a shaft such that the airfoil can be excited into a pitch oscillation about an axis at or close to the leading edge by actuating a trailing-edge flap. D. C. Morris' international patent application WO 2006/093790 for an “oscillating fluid power generator” was published on 8 Sep. 2006. He, too, proposes the use of a single or multi-element airfoil which pivots about a vertical mast. These recent inventions overlook the need for a large amplitude oscillatory plunge motion (typically of the order of one wing chord length) in order to achieve optimum performance.

### SUMMARY OF THE INVENTION

Accordingly, the present invention retains the ability to produce large amplitude combined pitch-plunge oscillations of a wing with a phase angle of approximately 90 degrees between the two oscillations. However, the previously described mechanical system to enforce this phase angle is replaced by a system which requires no elaborate mechanism to enforce the wing's pitch-plunge motion at the proper phase angle between the pitch and plunge motions. This is made possible as follows:

Consider a wing which is mounted on a swing arm which, in turn, is supported by a bearing, thus allowing the swing arm to oscillate about the bearing axis with a finite angular amplitude. Furthermore, the wing is mounted on the swing arm in such a way that the wing can pitch about a pitch axis perpendicular to the swing arm. This pitch axis is chosen to be downstream of the wing's mid-chord point so that the wing's lift force always generates a moment about said pitch axis which tends to increase the pitch angle. It is well known that a symmetric wing (with zero camber) set in a flow at zero angle of attack induces a drag force in the flow direction but no lift force perpendicular to the wing. If the wing is forced to move, say to the right, then an angle of attack and therefore a force is induced which opposes the motion. However, if the wing is set at a large positive pitch angle prior to the motion to the right, a lift force to the right is induced. This lift force will be decreased due to the wing's motion to the right, but the motion to the right will continue as long as a net force to the right is maintained by keeping the wing's pitch angle sufficiently large. Hence work is done by the fluid on the wing during its motion to the right. This same effect occurs during the reverse stroke to the left if the wing is set at a sufficiently large negative pitch angle at the start of the reverse stroke. At the right stroke end point therefore the wing pitch angle must be reset as quickly as possible from a relatively large positive pitch angle (typically between 50 to 80 degrees) to a negative pitch angle of the same value and at the end of the stroke to the left it must be reset from the negative pitch angle to the positive pitch angle.

The setting and maintenance of the required large positive or negative pitch angles during the right and left strokes, respectively, is accomplished by restraining the wing from exceeding the desired pitch angle by physical contact between the wing and a suitable contact surface. Furthermore, the wing will always be pressed against the contact surface, thus maintaining the desired pitch angle, because the pitch axis is located downstream of the mid-chord point and therefore a hydrodynamic or aerodynamic moment is generated which tends to turn the wing to its maximum possible pitch angle. Hence no separate mechanical system is required to enforce the proper pitch angle during the wing oscillation.

It remains to reset the pitch angle as quickly as possible at the stroke ends. This is again accomplished with the help of the water or air flow rather than by a mechanical system. To this end two switching rods are mounted in such a way that a spike attached to the wing leading edge starts to touch the right or left switching rod at the end of the right and left strokes, respectively. This forces the wing to rotate about the switching rod because an aerodynamic or hydrodynamic pitching moment is generated which changes the pitch angle from positive to negative on the right end of the stroke and from negative to positive on the left end.

Tests of a prototype power generator in water and air verified the feasibility and practicality of the above described flow-induced oscillation mechanism. They also confirmed the computational predictions of M. F. Platzer, J. Young, J. C. S. Lai, ICAS Paper 2008-1.5.1 “Flapping-Wing Technology: The Potential for Air Vehicle Propulsion and Airborne Power Generation”, 26^{th} Congress of the International Council of the Aeronautical Sciences, Anchorage, Ak., 14-19 Sep. 2008. In this paper it was shown that flow-induced oscillation produces a greater power output per cycle than mechanically-induced oscillation. This is due to the fact that flow-induced oscillation produces a trapezoidal pitch amplitude variation during the cycle in contrast to the sinusoidal variation enforced by mechanically enforced oscillation.

An alternative way of obtaining a large amplitude plunge (translatory) oscillation of the wing is obtained by replacing the swing arm by a guide rail. In this version the wing is hung vertically down from a horizontal guide rail by means of a sleeve so that the wing can glide along the rail. As in the swing-arm configuration, the wing can pitch about an axis located at or near the mid-chord point and the required large positive or negative pitch angles during the right and left strokes are enforced by physical contact between the wing and a suitable contact surface in a manner quite similar to the one used for the swing-arm generator. Also, stroke reversal is initiated in a similar fashion by attaching switching rods at the ends of the guide rail.

In summary, the proposed oscillating-wing power generator is fundamentally different from previously demonstrated oscillating-wing power generators because no mechanical linkages are needed to induce a self-excited oscillation. Instead, the needed phase angle between the pitch and plunge oscillations of the wing is produced by purely aerodynamic or hydrodynamic effects.

Those skilled in the art will envision other aerodynamic or hydrodynamic methods to generate the aerodynamic or hydrodynamic forces and moments necessary to initiate the stroke reversals described above, for example by means of control surfaces mounted on the wing. Furthermore, those skilled in the art recognize that the device described in the FIGS. 1 through 9 works equally well if the wing or sail is mounted horizontally instead of vertically.

A further advantage of the proposed configuration accrues for operation as a hydropower generator because the only part exposed to the water flow is the wing. All other parts, in particular the swing arm or the guide rail, are above the water surface. Furthermore, the hydropower generator can be mounted on a floating platform which is anchored in the tidal or river flow. Hence, the installation effort and the environmental impact are minimal.

### BRIEF DESCRIPTION OF THE DRAWINGS

FIG. 1 is a foil, exposed to an air or water flow, which can oscillate in two degrees of freedom, namely a plunge (translational) oscillation perpendicular to the flow and a pitch oscillation about a horizontal axis on the foil. In the upper part of the figure the two oscillations occur with a ninety degree phase angle, in the lower part the phase angle is zero. For the 90 degree phase angle case the lift (unshaded arrows) is always in phase with the motion (shaded arrows) and hence work is done by the air or water on the foil. In the case of zero phase angle the lift opposes the motion over parts of the cycle and the total work done is zero. It is the purpose of this figure to explain the need for a combined pitch and plunge oscillation and the importance of the proper phasing between the pitch and plunge oscillations.

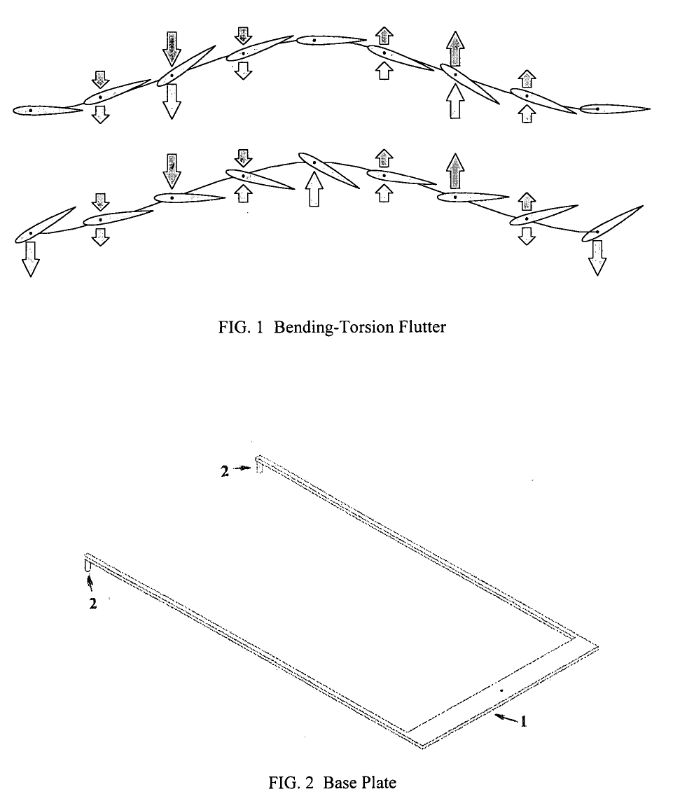

FIG. 2 is a diagram of the base plate and two arms 1. At the end of the two arms two rods 2 are attached. It is the purpose of these two rods to initiate the stroke reversal of the wing. These rods therefore are denoted as “switching rods”.

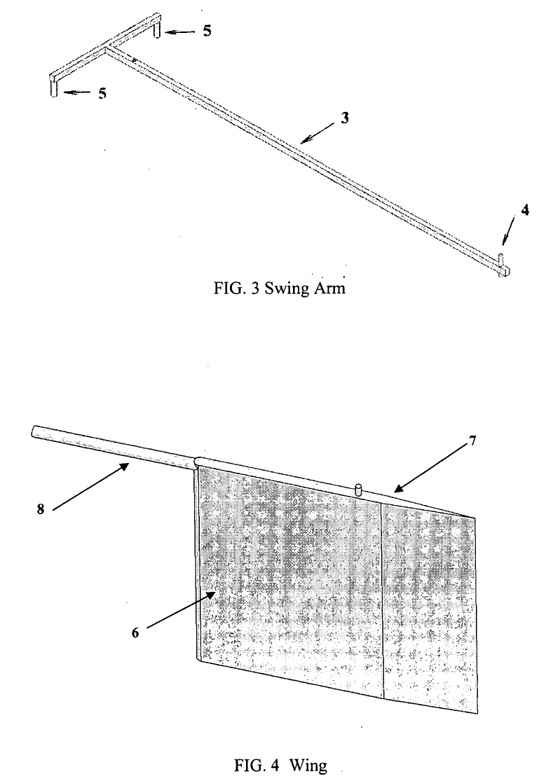

FIG. 3 is a diagram of the T-shaped swing arm 3. The axle 4 at one end of the swing arm enables the swing arm to oscillate about a vertical axis at the center of the base plate, indicated by the hole in the base plate shown in FIG. 2. Near the other end of the swing arm there is a hole, indicating the pitch axis of the wing. Also, at the ends of the T-bar two rods 5 are attached. It is the purpose of these rods to limit the pitch angle of the wing. These rods therefore are denoted as “pitch control rods” 5.

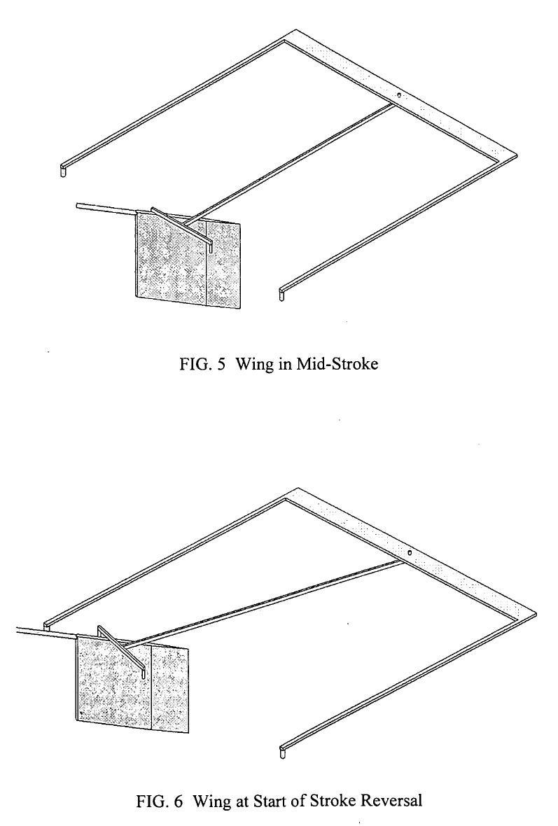

FIG. 4 is a diagram of the wing 6, together with an axle 7 located at a point in excess of one half chord length from the leading edge. It is the purpose of this axle to enable the wing to rotate about the hole shown on the swing arm to a pitch angle limited by the pitch control rods. Also, the upper end of the wing leading edge is extended with a spike 8. It is the purpose of this spike to engage the switching rods for the purpose of initiating the stroke reversals.

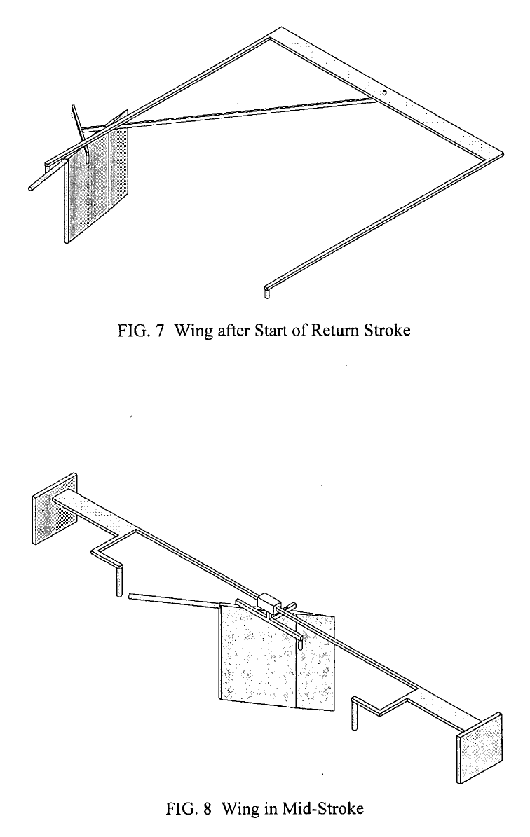

FIGS. 5 to 9 show the operation of the swing-arm and of the rail-guide versions of the invention.

### DETAILED DESCRIPTION OF THE INVENTION

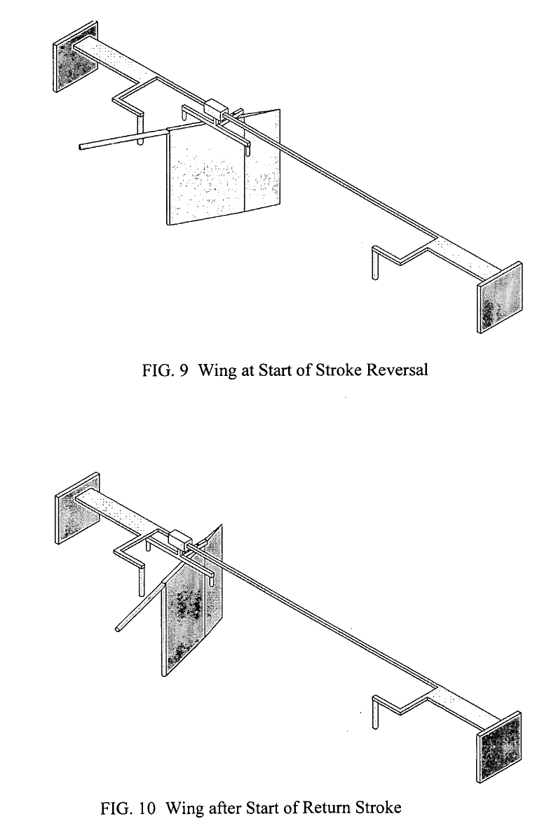

The essence of the proposed new power generator can be understood from FIGS. 5 and 6. The generator consists of the following parts: the base plate with the two support arms 1 and the two switching rods 2, the swing arm 3 with the axle 4 and the two pitch control rods 5, the wing 6 with the pitch axle 7 and the spike 8.

The principle of operation is as follows: The swing arm 3 oscillates about a vertical axis, indicated by the hole on the base plate 1, with an angular amplitude which is limited by the location of the switching rods 2. At the other end of the swing arm the wing 5 is attached to the swing arm 3 by means of the axle 4 so that it can pitch about an axis perpendicular to the swing arm and the base plate. At the end of each clockwise and counterclockwise stroke the wing 6 must be rotated quickly to the proper pitch angle. Denoting a pitch angle where the wing's leading edge points to the right as positive the wing must be set at a positive pitch angle during its right stroke so that a lift is generated which points right. The air or water flow is assumed to be parallel to the two legs of the base plate in the direction toward the axis of the swing arm. Since the wing's pitch axis is placed at a sufficiently far downstream location a moment is generated which deflects the wing to its maximum possible pitch angle. This maximum pitch angle is determined by the location of the pitch control rods 5. At the end of the clockwise stroke the wing pitch angle must be reset to a negative pitch angle of the same magnitude so that the wing is pushed to the left. This switching action is accomplished by physical contact between the spike 8 on wing 6 and the switching rod 2 on the right support arm. As a consequence, a hydrodynamic or aerodynamic moment is generated which rotates the wing 6 to its maximum negative pitch angle and thus initiates the counterclockwise stroke. Note that during the clockwise or counterclockwise stroke the wing is set at a sufficiently large pitch angle to generate a lift force which always points in the direction of the motion, hence transferring work from the water or air stream to the wing. This pitch angle is maintained throughout the stroke because the pitch axis is located downstream of the mid-chord axis, hence the wing 6 generates a hydrodynamic or aerodynamic moment about the pitch axis which forces the wing 6 to touch one of the pitch control rods 5. The distance between the two pitch control rods 5 determines the wing's pitch angle, whereas the distance between the two switching rods 2 determines the stroke amplitude.

FIG. 5 shows the wing during the middle of the clockwise stroke. Note that the wing touches the right pitch control rod 5.

FIG. 6 shows the wing toward the end of the clockwise stroke as it starts to touch the right switching rod 2 to initiate stroke reversal.

FIG. 7 shows the wing at a somewhat later time during the stroke reversal at the right side.

FIGS. 8, 9 and 10 show the guide-rail version of the invention. The swing arm is replaced by the rail guide.

FIG. 8 shows the wing during the middle of the clockwise stroke. Note that the wing is fully deflected in pitch, touching the right pitch control rod 5.

FIG. 9 shows the wing toward the end of the clockwise stroke as it starts the right switching rod 2 to initiate the stroke reversal.

FIG. 10 shows the wing shortly after the start of the return stroke.

1. For use in generating electrical energy from air or water flows, apparatus comprising: a base plate, a swing arm and a wing or sail, where the wing or sail is mounted on the swing arm in such a way that it is aerodynamically or hydrodynamically unstable, thus generating a force which causes the swing arm to move; the motion being reversed by the generation of an aerodynamic or hydrodynamic pitching moment at the end of the stroke which rotates the wing or sail and generates an aerodynamic or hydrodynamic force to drive the wing or sail in the opposite direction, thereby inducing an oscillatory motion of the swing arm by purely aerodynamic or hydrodynamic means.

2. For use in generating electrical energy from air or water flows, apparatus comprising: a guide rail and a wing or sail, where the wing or sail is attached to the guide rail in such a way that it can glide back and forth on the guide rail. The wing or sail is mounted in such a way that it is aerodynamically or hydrodynamically unstable, thus generating a force which causes the wing or sail to move along the rail; the motion being reversed by the generation of an aerodynamic or hydrodynamic pitching moment at the end of the stroke which rotates the wing or sail and generates an aerodynamic or hydrodynamic force to drive the wing or sail in the opposite direction, thereby inducing a large-amplitude translatory oscillation of the wing or sail by purely aerodynamic or hydrodynamic means.

3. Apparatus as claimed in claim 1 in which the pitching moment at the end of the stroke to initiate stroke reversal is generated by the rotation of the wing or sail around a point as shown in the drawings and description further below or by other state-of-the-art aerodynamic or hydrodynamic means, such as control surfaces mounted on the wing or sail and actuated at the proper time.

4. Two apparatuses as claimed in claims 1 or 2 connected together in such a manner that one wing or sail is at the middle of the power stroke while the other is at the end of the stroke, thereby achieving a self-starting smooth operation of both apparatuses.

5. Two apparatuses as claimed in claim 1 connected together in such a manner that the individual wings or sails are oscillating in counterphase, thereby producing a dynamically balanced system.
